(19) United States
(12) Patent Application Publication
(10) Pub. No.: US 2010/0032945 A1
(43) Pub. Date: Feb. 11, 2010

(54) APPARATUS FOR CONNECTING TUBULAR BODIES

(76) Inventor: William J. Baker, Manifee, CA (US)

Correspondence Address: C. JAMES BUSHMAN, 5851 San Felipe, SUITE 975, HOUSTON, TX, 77057, US

(21) Appl. No.: 12/298,548

(22) PCT Filed: Apr. 30, 2007
(86) PCT No.: PCT/US07/10456

§ 371 Date: Jul. 6, 2009

Related U.S. Application Data
(60) Provisional application No. 60/796,061, filed on Apr. 28, 2006.

(51) Int. Cl. F16L 21/02

(52) U.S. Cl. 285/368

(57) ABSTRACT

An apparatus for connecting first and second tubular members, the first and second tubular members having end faces and registering seal ring grooves, formed in the end faces, both of the tubular bodies having an externally threaded portion extending away from the end faces, a first annular hub having an internally threaded portion threadedly received on the first tubular body, the first hub having radially outwardly facing frustoconical surface, a first annular flange in surrounding relationship to the first hub, the first flange having a radially inwardly facing frustoconical surface that mates with the frustoconical surface on the hub, a second hub having a internally threaded portion for mating with the externally threaded portion on the second tubular body and having an annular radially inwardly facing frustoconical surface, a second flange in surrounding relationship to the second hub, the flange having a radially inwardly facing frustoconical surface for engaging the frustoconical hub surface, a seal ring disposed in the registering seal ring grooves and a compression assembly connected to the flanges to urge the flanges and the hubs towards one another and the seal ring and the metal-to-metal sealing engagement with the first and second tubular bodies.

### CROSS REFERENCE TO RELATED APPLICATION

This application claims the priority of U.S. Provisional Application No. 60/796,061 filed on Apr. 28, 2006, the disclosure of which is incorporated herein by reference for all purposes.

### BACKGROUND OF THE INVENTION

1. Field of the Invention

The present invention relates to an apparatus for connecting components such as tubular members.

2. Description of Prior Art

Connections between pipe sections, a pipe section and a valve, or between any two bodies having tubular portions that are connectable to provide a fluid flow passage are commonly made using flange assemblies. One type of flange assembly, commonly referred to as a swivel flange assembly, has two subassemblies, each having a flange or collar that is rotatable and axially movable relative to a hub or nipple. In these swivel flange assemblies, the hub or nipple is provided with a radially outwardly facing, annularly extending groove into which are received split ring segments. The split rings project radially outwardly from the groove in the hub or nipple and provide a right-angled shoulder against which one flange is urged as it is bolted to the adjoining flange. This shoulder supports the loads imposed by the bolts holding the flange assemblies together. While other prior art swivel-type flange assemblies have tapered hubs and flanges, for all intents and purposes the taper angle is so large, e.g., 65°, that they behave essentially like a right-angled shoulder. Because of this type of shouldering, high stress concentrations are created at the juncture of the shoulder(s) and the hub(s) or nipple(s).

In flange assemblies, both of the standard and swivel type, metal seal rings have been utilized to obtain metal-to-metal sealing between the two flange subassemblies. Typically, this has necessitated that a metal seal ring, or at least a portion thereof, be compressed between the hub faces by the nut and bolt assemblies used to clamp the flange subassemblies together. However, in these types of prior art flange assemblies, there typically is not metal-to-metal sealing between the hub faces themselves as opposed to being between the hub faces and the seal ring or a portion thereof compressed therebetween.

### DESCRIPTION OF THE PREFERRED EMBODIMENTS

The present invention is an improvement in the apparatus disclosed and/or claimed in U.S. Pat. Nos. 6,394,507 and 6,715,802 (Baker Patents), both of which are incorporated herein by reference for all purposes.

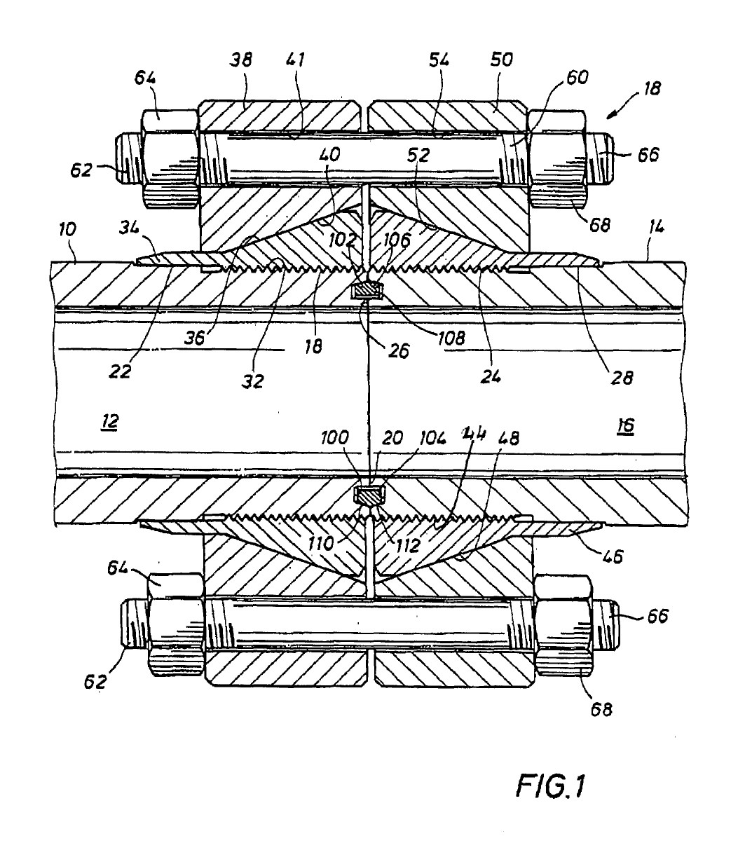

Referring first to FIG. 1, there is shown a first tubular member 10 having a flow passage 12 and a tubular member 14 having a flow passage 16. Tubular member 10 has an externally threaded portion 18 extending from an end or face 20 of tubular member 10, tubular member 10 having a reduced diameter portion 22 extending axially away from threaded portion 18. In like fashion, tubular member 14 has an externally threaded portion 24 extending axially away from end or face 26 of tubular member 14 and a reduced diameter portion 28 extending axially away from threaded portion 24. A first hub 30 has an internally threaded portion 32 which mates with threaded portion 18 whereby hub 30 can be screwed onto tubular member 10. Hub 30 also has an axially extending annular skirt 34 received in the recess formed by reduced diameter portion 22 on tubular member 10. Hub 30 has an annular, radially outwardly facing, frustoconical surface 36 in generally surrounding relationship to threaded portion 32. An annular flange 38 has an annular radially inwardly facing frustoconical surface 40 which mates with frustoconical surface 36, flange 38 having a series of circumferentially spaced bolt holes 41. A second hub 42 has an internally threaded portion 44 which mates with threaded portion 24 on tubular member 14 whereby hub 42 can be threadedly received on tubular member 14. Hub 42 has an axially extending, annular skirt 46 which, when hub 42 is screwed onto tubular member 14 is received in the annular recess formed by reduced diameter portion 28 of tubular member 14. Hub 42 has an annular, radially outwardly facing frustoconical surface 48 in generally surrounding relationship to threaded portion 44. A second flange 50 surrounds hub 42 and has an annularly extending, radially inwardly facing frustoconical surface 52 which, as seen, mates with frustoconical surface 48. Flange 50 is further provided with a series of circumferentially spaced bolt holes 54. Bolts 60 are received in registering bores 41 and 54, bolts 60 having a first threaded end 62 on which is received a nut 64 and a second threaded end 66 on which is received a nut 68.

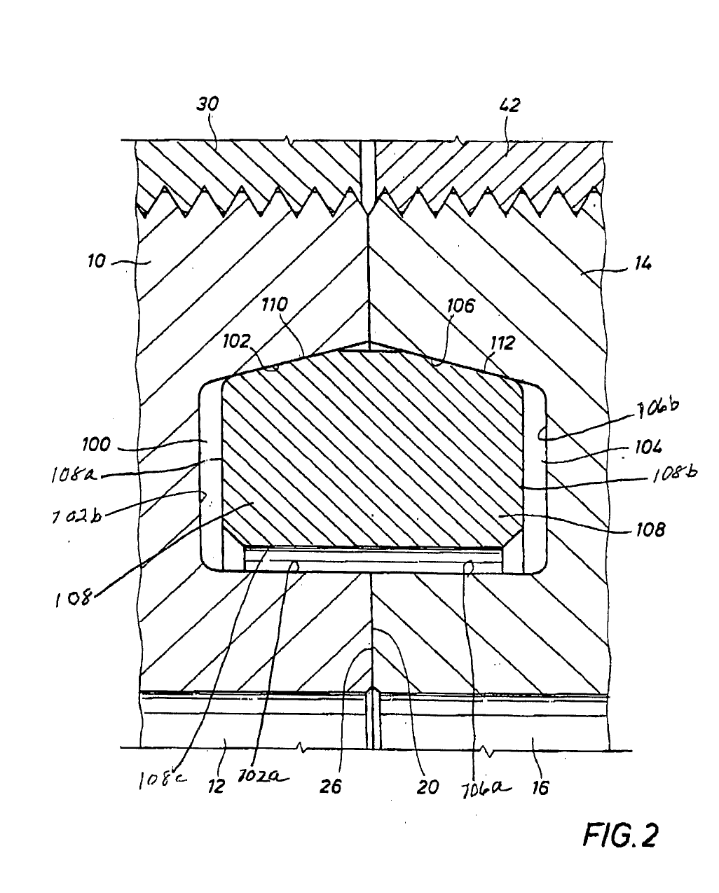

Formed in the end face 20 of tubular member 10 is an axially facing, annular groove 100, shown in greater detail in FIG. 2. Annular groove 100 has an annularly extending, radially inwardly facing, frustoconical wall 102, an annular, generally cylindrical radially innermost wall 102a and an annular, radially extending end wall 102b. Formed in end face 26 of tubular member 14 is an axially facing, annularly extending groove 104, groove 104 having an annular, radially inwardly facing, frustoconical wall 106, an annular, generally cylindrical innermost wall 106a and an annular, axially facing end wall 106b, grooves 104 and 100 being in register with one another. Disposed in registering grooves 100 and 104 is an annular seal ring 108, annular seal ring having a first, annular radially outwardly facing frustoconical surface 110 and a second, annular radially outwardly facing frustoconical surface 112. Seal ring 108 also has a first annular, radially extending end surface 108a and a second annular, radially extending end surface 108b, surface 108a being proximate to but spaced from wall 102b, surface 108b being proximate to but spaced from wall 106b. Seal ring 108 further includes an annular, radially inwardly facing cylindrical surface 108c, surface 108c being spaced from walls 102a and 106a. As will be seen hereafter, when the assembly is fully made up, frustoconical surfaces 110 and 112 are in metal-to-metal sealing engagement with frustoconical surfaces 102 and 106, respectively, providing metal-to-metal sealing between tubular members 10 and 14. It will also be appreciated that when the assembly is fully made up, that the end faces 26 and 20 of tubular members 10 and 14, respectively, are also in metal-to-metal sealing engagement. It will thus be appreciated that the metal-to-metal sealing between seal ring 108 and tubular members 10 and 14 as well as the direct metal-to-metal sealing between tubular members 10 and 14 on their faces 26 and 20, respectively, provide an extraordinarily high pressure seal between tubular members 10 and 14.

In a preferred embodiment, and prior to make-up of the assembly, the diameters of the frustoconical surfaces on the seal ring 108 are greater than the diameters of the frustoconical surfaces in the grooves 100 and 104 by an amount that permits substantially full interference and engagement of the frustoconical surfaces on the seal ring 108 with at least a portion of the frustoconical surfaces in the seal ring grooves 100 and 104, but prevents engagement of the faces 20 and 26 without the nut/bolt combinations 60, 62 and 68 being tightened sufficiently to result in a radially, inwardly compressive force on the seal ring 108 sufficient to permit metal-to-metal engagement of the faces 20 and 26. Thus, the relative sizing should be such that when fully made up the seal ring is under compressive loading which is greater than about 30% of the yield point of the material of the seal ring 108. Accordingly as the connection assembly is made up, the seal ring 108 is compressed radially inwardly. However, because there are clearances between the axially facing end walls 102b and 106b, respectively, of the grooves 100 and 104 and the axially facing surfaces 108a and 108b, respectively, of the seal ring 108, as well as an annular clearance between the annular, radially inwardly facing surface 108c of the seal ring 108 and the annular, radially outwardly facing walls 102a and 106a partially forming the grooves 100 and 104, respectively, the seal ring 108 is at all times free to float within those clearances. This unique design prevents the seal ring 108 from being excessively deformed, unlike metal seal rings used in standard flange designs, which, of necessity, require that the metal seal rings effectively be crushed to effect metal-to-metal sealing. This oversizing of the seal ring 108 relative to the grooves 20 and 26 as discussed above intentionally induces compressive strain on the seal ring 108 in a collapse mode that exceeds the yield strength of the material from which the seal ring 108 is made. This ensures that the frustoconical surfaces of the seal ring 108 and the frustoconical walls of the seal ring grooves are firmly seated against one another with a compressive-bearing stress that essentially matches the yield strength of the material of the seal ring 100.

Unlike the apparatus disclosed in the Baker Patents, in the present invention the grooves 100 and 104 are formed in the abutting ends of the tubular members 10 and 14. In this regard, the present invention is ideally suited for heavy wall pipe wherein such grooves can be accommodated.

Extrapolating an FEA analysis applied to an assembly wherein the hubs are welded to the pipe as shown in the Baker Patents, it can be postulated how the apparatus of the present invention would behave. If it is considered that the two parts, the hub and the tubular member are not in solid contact with each other, the stress on the engaged threads between the hub and the tubular member would be about 12,000 psi. If the hub and pipe are in intimate, solid contact the stress would flow all the way to the I.D. of the tubular member and an FEA analysis would be essentially the same as for one solid hub, i.e., the hub welded to the tubular member. As a practical matter, solid intimate contact in the threaded portions will not occur inasmuch as the threaded engagement between the tubular member and the hub is in solid contact only on one side of the threads. The other side of the threads has an air gap. Accordingly, it is postulated that compressive stress originating from the bolt load on the flanges as translated through the hub and into the tubular member would be similar to an FEA analysis for a hub welded to the tubular member. The stresses on the threaded portions between the hub and tubular member, which are normally shear stresses in the case of a single bolt, would in this case be reduced by virtue of the fact that there is a compressive stress at 90° to the shear stress.

To avoid thread shear failure at high loading, it is desirable that the thread shear area between the hub and the tubular member be chosen so as to be greater than about double the amount of thread shear area in the bolts used to connect the assembly.

It should also be noted that the skirts 34 and 46 which are received in the recesses formed by reduced diameter portions 22 and 28, respectively, act as a guide when starting to thread the hubs onto the pipes or tubular members. Additionally, this extended axial length of the hubs provides additional strength to resist external bending moments since the skirts 34, 36 are closely fitted to the reduced diameter portions of the tubular members.

It will be understood from the above that the only force transmitting contact between the flanges and the hubs is through the mating frustoconical surfaces on those members. In this regard, the inner engaged frustoconical surfaces on the hubs and flanges are leveraged together by the load imposed by the threaded studs and nuts, i.e., the compression assembly used to force the flanges against the hubs. The clamping load developed by the studs and nuts is applied to the frustoconical surfaces of the flanges and hubs and results in compressive stresses being developed in the hubs which are beneficial because they can reduce an often completely offset tensile stresses resulting from internal flow line pressure.

Preferably the angle as measured between an axis coaxial with the first and second tubular members once the first and second seal ring grooves are in register and an imaginary line passing through either of the frustoconical surfaces on the first and second hubs is from 10° to 30° more preferably from about 12° to about 25°.

As noted, with the apparatus of the present invention, metal-to-metal sealing occurs between the end faces of the tubular members when the connection assembly is fully made up. To enhance this metal-to-metal sealing, the end surfaces or faces should be provided with good flat finishes and the stud nuts assemblies evenly tightened. Metal-to-metal sealing between the end faces of the tubular members is enhanced by choosing a face contact area that develops compressive stresses in the range of 60% to 90% of the yield point so the material of the tubular members as a result of a tightening of the compression assembly, i.e., the studs and nuts to the prescribed load. Additionally, it is preferred that the axial end faces of the tubular members have a finish of approximately 63 to 100 RMS, which can be accomplished, for example, by making a face cut on the lathe. As is well known, such a face cut will result in a surface with peaks or crests generated by the cutting tool. Although slight, these peaks or crests can be felt if a fingernail is run over the surface. However, when the load imposed by the studs and nuts results in a calculated compressive stress on the end faces of the tubular members of 60% to 90% of the yield point of the material of the tubular members, the yield point of the material of the peaks or crests will be exceeded, forcing the peaks or crests to flatten, creating a metal-to-metal seal.

The metal seal ring used in the apparatus of the present invention provides exceptional sealing capability at wide ranges of temperatures and pressures. Both high and low pressures are sealed by an interference dimensioning of the frustoconical surfaces in the seal ring grooves and the seal ring, in the range of 5° to 25°, preferably 10° to 20°, as measured between an imaginary line through the frustoconical surfaces on the seal ring and the axis or centerline of the tubular members.

The foregoing description and examples illustrate selected embodiments of the present invention. In light thereof, variations and modifications will be suggested to one skilled in the art, all of which are in the spirit and purview of this invention.

What is claimed is:

1. An apparatus for connecting first and second tubular bodies comprising:
a first tubular body having a first end face and a first externally threaded portion extending axially away from said first end face, said first tubular body having a first, annular seal ring groove formed in said first end face;
a first annular hub having a first, internally threaded portion for mating with said first externally threaded portion on said first tubular body and having a first, annularly extending, radially outwardly facing frustoconical hub surface;
a first annular flange in surrounding relationship to said first hub, said first flange having a first, annularly extending, radially inwardly facing frustoconical flange surface, said first frustoconical flange surface and said first frustoconical hub surface being complimentary to one another;
a second tubular member having a second end face and a second externally threaded portion extending away from said second end face, said second tubular member having a second annular seal ring groove formed in said second end face;
a second hub having a second, internally threaded portion for mating with said second externally threaded portion on said second tubular body and having a second, annularly extending, radially outwardly facing frustoconical hub surface;
a second annular flange in surrounding relationship to said second hub, said second flange having a second annularly extending, radially inwardly facing frustoconical flange surface, said second frustoconical flange surface being complimentary to said second frustoconical hub surface;
a seal ring having a first portion disposed in said first annular seal ring groove and a second portion disposed in said second annular seal ring groove; and
a compression assembly operatively connected to said first and second flanges to urge said first and second flanges and said first and second hubs towards one another and said seal ring into metal-to-metal sealing engagement with said first and second tubular bodies.

2. The apparatus of claim 1, wherein each of said first and second seal ring grooves are defined by an annular, radially innermost wall, an annular, radially outermost wall, and an axially facing end wall connecting said radially innermost and radially outermost walls and said radially outermost walls comprising radially inwardly facing, annularly extending frustoconical groove surfaces.

3. The apparatus of claim 2 wherein said seal ring comprises an annular metallic ring, said seal ring having a first portion received in said first seal ring groove and a second portion received in said second seal ring groove, said first portion of said seal ring having a first radially outwardly facing, annularly extending frustoconical seal ring surface, said second portion of said seal ring having a second radially outwardly facing, annularly extending frustoconical seal ring surface, said frustoconical seal ring surfaces being dimensioned relative to said frustoconical groove surfaces such that, prior to metal-to-metal engagement between said first and second end faces, there is interference engagement between said first frustoconical seal ring surface with at least a portion of said frustoconical groove surface in said first seal ring groove and interference engagement between said second frustoconical seal ring surface with at least a portion of said frustoconical groove surface in said second seal ring groove.

4. The apparatus of claim 1 wherein said first and second hubs are monolithic bodies.

5. The apparatus of claim 1 wherein said first and second flanges have axially extending holes, at least some of said axially extending holes in said first flange being in register with at least some of said axially extending holes in said second flange and said compression assembly studs received in said registering holes, said studs having a first threaded end extending axially outwardly of said first flange and a second threaded end extending axially outwardly of said second flange and there is a first threaded nut received on said first threaded end and a second threaded nut received on said second threaded end.

6. The apparatus of claim 3 wherein said seal ring is spaced from said end walls and said radially innermost walls of said first and second seal ring grooves when said seal ring is in metal-to-metal sealing engagement with said first and second tubular members.

7. The apparatus of claim 1 wherein the angle between an axis coaxial with said first and second tubular members when said first and second seal ring grooves are in register and an imaginary line passing through either of said frustoconical surfaces on said first and second hubs is from 10′ to 30′.

8. The apparatus of claim 1, wherein prior to connection of said first and second tubular members, said first annular flange is rotatable about said first hub and said second annular flange is rotatable around said second hub.

9. The apparatus of claim 1, wherein said first and second flanges are monolithic bodies.
